(19) United States
(12) Patent Application Publication
(10) Pub. No.: US 2007/0097351 A1
(43) Pub. Date: May 3, 2007

(54) Rotary menu display and targeting reticles for laser rangefinders and the like

(75) Inventors: Andrew W. York, Portland, OR (US); Victoria J. Peters, Forest Grove, OR (US); Michael Slack, Portland, OR (US)

Correspondence Address: STOEL RIVES LLP, 900 SW FIFTH AVENUE, SUITE 2600, PORTLAND, OR, 97204-1268, US

(73) Assignee: Leupold & Stevens, Inc., Beaverton, OR (US)

(21) Appl. No.: 11/265,546

(22) Filed: Nov. 1, 2005

(51) Int. Cl. G01C 3/08; G06F 3/00

(52) U.S. Cl. 356/5.02; 356/139.01; 42/119; 715/700

(57) ABSTRACT

An interactive menu system and method of operating a menu display are disclosed. User-configurable targeting reticles and rangefinder information display methods are also disclosed. The systems and methods described herein are particularly suited for use with an aimed optical device, such as a laser rangefinder or riflescope, for example.

### TECHNICAL FIELD

This disclosure relates to displays, menus, and targeting reticles for rangefinders and other aimed optical devices having a field of view or viewfinder.

### BACKGROUND OF THE INVENTION

Handheld laser rangefinders and other aimed optical devices, such as riflescopes, spotting scopes, night vision scopes, binoculars, cameras, and the like often have integrated electronic systems and controls that have user-selectable feature settings. Some known rangefinders and cameras include display devices that are driven by an electronic controller and designed to display an interactive setup menu that allows a user to select from various operational modes or features, depending on environmental conditions and/or the needs of the user. In some such devices, the menu display is viewable through an optical targeting sight or other optical system of the device. In other aimed optical devices, a menu display is viewable in the viewfinder or other optical system of the device, or on an external electronic display panel.

The interactive menu systems in known laser rangefinders and other aimed optical devices are often confusing to operate. They may present feature options in a list or table, using several levels of hierarchy or without any meaningful organization. Such menus can be difficult to navigate without a user manual.

Laser rangefinders and riflescopes typically include targeting reticles. Some known targeting reticles are generated by an electronic display device, such as a liquid crystal display (LCD) positioned in the optical path. Some LCD displays may be illuminated by light reflected off the surface of the display elements, while others may provide only opaque display elements that are visible in the field of view. Various other display technologies, such as etched side-illuminated displays, organic light emitting diodes (OLED), fiber optics, and others are also known for generating reticle displays in the field of view and may be useful for certain embodiments of the inventions disclosed herein.

Electronic displays in rangefinders may facilitate the display of variable digital data, such as a range-to-target readout, in the field of view of the optical device. Menu displays, digital readouts, and reticles are also known to be patterned in a single LCD display panel in a rangefinder. However known rangefinders continuously display range data and other information adjacent the reticle, which the present inventors have found tends to obscure the field of view and inhibit target acquisition.

The present inventors have recognized a need for improved menu systems and methods of operating interactive menus and data displays in a rangefinder or other aimed optical device; and for improved reticle display systems for aimed optical devices.

### BRIEF DESCRIPTION OF THE DRAWINGS

FIG. 1 is a perspective view of a laser rangefinder according to a preferred embodiment;

FIG. 2 is a view of a display of the rangefinder of FIG. 1 with all menu display elements and targeting display elements shown for purposes of illustration;

FIG. 3 is a view through an aiming scope of the rangefinder of FIG. 1 showing a first menu selection of the display of FIG. 2;

FIG. 4 is a view through the aiming scope of the rangefinder of FIG. 1, showing a targeting reticle display and leaving all menu icons of FIG. 2 turned off;

FIG. 5 is a view through the aiming scope of the rangefinder of FIG. 1, with the display showing a targeting reticle and a display readout of measurements to a target at which the rangefinder is aimed; and

FIGS. 6A-6M are selectable reticle configurations of the targeting display elements shown in FIG. 2.

### DETAILED DESCRIPTION OF PREFERRED EMBODIMENTS

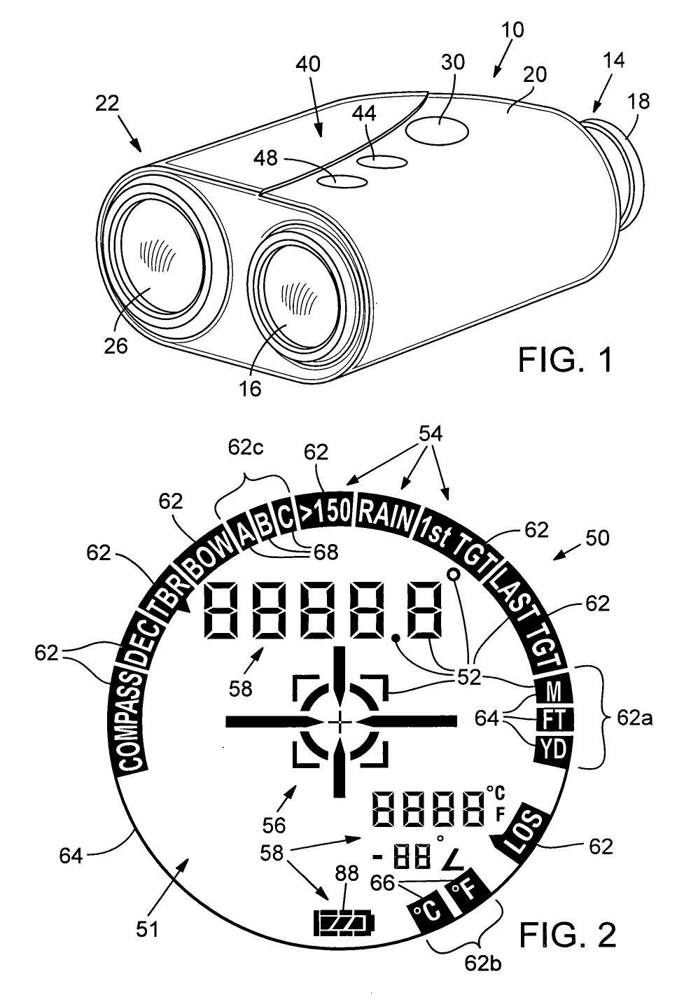

In accordance with one embodiment, a handheld rangefinder 10 is depicted in FIG. 1. Rangefinder 10 includes a telescopic monocular targeting sight 14 having an objective 16 and an eyepiece 18 supported in a common housing 20 along with a laser ranging system 22 and associated electronics. Laser ranging system 22 projects a laser beam (not shown) through a rangefinder lens 26. Laser light reflected by a distant target (not shown) is then received by laser ranging system 22 through rangefinder lens 26 or another lens or receiver, and a lag time between the emission and reception of the laser light measured to determine a distance (range) from the rangefinder 10 to the target. This ranging technique is known to some as lidar. The actual methods employed by rangefinder 10 for determining the time between emission and reception of laser light and for calculating a line-of-sight range to the target may comprise any of a variety of methods. Rangefinder 10 may have an operating range from approximately three yards or less, to approximately 1,200 yards or more, depending on the reflectivity and size of the target, and possibly other factors.

Rangefinder 10 includes a power button 30 that is initially depressed to power up the rangefinder 10 and turn on the rangefinder's electronics, including a computer processor thereof. Power button 30 may thereafter be depressed and preferably held for a period of time (e.g., for one second or more) to turn off the electronics when desired. To help conserve battery power, an automatic timeout feature may also turn off the electronics after a period of inactivity, such as inactivity of more than 5 or 10 seconds. Rangefinder 10 may also include a menu interface 40 including a mode selector button 44 and a setting adjustment button 48, which are further described below with reference to FIGS. 2-4. Skilled persons will appreciate that menu interface 40 may include more or fewer buttons, or controls of a different type, such as keypads, adjustment knobs, wheels, dials, touch screens, wired or wireless electronic interfaces, remote controls, and any other device through which a user can interface with and provide input to rangefinder 10.

FIG. 2 depicts an electronic display 50 of rangefinder 10, as viewed through eyepiece 18. Electronic display 50 is superimposed on a field of view 51 of the targeting sight 14, and includes a plurality of display elements 52 that may be individually controllable for display or blanking by one or more digital processor components of the electronics of rangefinder 10. For purposes of illustration, all display elements 52, including elements of a menu display 54, a targeting display 56, and a data display 58 are shown in FIG. 2.

In one embodiment, electronic display 50 comprises an LCD panel positioned in the optical path of targeting sight 14 between objective 16 and eyepiece 18. The LCD panel includes normally-transmissive layers so that it does not obscure the field of view. For example, LCD panel may include transmissive electrodes formed of indium tin oxide (ITO). Display elements 52 may be reflective or opaque, or both, when active. A source of Illumination (not shown) may optionally be provided in targeting sight 14 for illuminating active display elements 52 to enhance their visibility in low ambient light conditions. The illumination source may be integrated in targeting sight 14 in such a manner so as to prevent illumination from being projected out of objective 16 toward a target. In other embodiments (not shown), electronic display 50 may comprise any of a variety of electronic display devices other than or in addition to an LCD display. For example, electronic display 50 may comprise fiber optic displays, light emitting diodes (LEDs), organic light emitting diodes (OLEDs), and others. Moreover, the display device need not be located in the optical path. For example, a display device such as an LCD, DLP, or another display device outside of the optical path may project an image of the menu, reticle, and data displays 54, 56, 58 onto a prism or reversed beam splitter located in the optical path.

### Rotary Menu Display

With reference to FIG. 2, menu display 54 includes a plurality of menu icons 62 distributed along a perimeter 64 or periphery of the field of view 51. Some or all of menu icons 62 may touch, abut, or overlap the perimeter or periphery of the field of view 51, or may be radially adjacent the perimeter. The perimeter 64 may be defined by the outer limits of the targeting sight 14, such as the boundaries of an exit pupil of the optical system of targeting sight 14, or by the edges of a targeting display screen. Adjacent menu icons 62 may touch or be spaced apart along the periphery or perimeter 64. The field of view 51 and the perimeter 64 may be circular, as shown in FIGS. 2-5, or may be of another shape, such as rectangular or square. Similarly, the menu icons 62 may be generally arranged in the shape of a circle, arc, rectangle, square, or another shape defined by perimeter 64.

Menu icons 62 may comprise graphical icons, text displays, or combined text and graphical icons as shown in FIG. 2. Each of the menu icons 62 preferably identifies an adjustable feature of the rangefinder. For example, one or more of the following menu icons 62 and corresponding adjustable features may be included:

| Icon Label(s) | Feature Description |
|---|---|
| >150 | Long range mode - ignores objects (brush, |
| | etc.) closer than 150 yards |
| RAIN | Rain mode - filters out effects of rain |
| 1^{st} TGT | Measures range to closest target |
| LAST TGT | Measures range to furthest target |
| M - FT - YD | Units of range measurement(s) |
| LOS | Displays line-of-sight range |
| ° F. - ° C. | Temperature display mode and units |
| COMPASS | Compass mode - displays compass heading |
| DEC | Declination adjustment for compass mode |
| TBR | Displays TRUE BALLISTIC RANGE ™ |
| | (equivalent horizontal range for holdover |
| | adjustment during incline shooting) |
| BOW | Bow hunting mode - affects TBR calculations |
| A - B - C | Ballistic group - affects TBR calculations |

Some of the features, such as long range mode (>150), rain mode (RAIN), and others, may be adjustable only in that they can be toggled on and off (enabled and disabled). Others of the features, such as the units of range measurement (M-FT-YD), temperature display units (° F-° C), and ballistic groupings (A-B-C) MAY PROVIDE for selection of one of several possible mutually-exclusive predefined settings, which are defined by corresponding icons 62a, 62b, and 62c each of which comprises multiple adjacent display segments 64, 66, and 68 indicating the possible settings. Still other features, such as declination (DEC), may involve adjustment of a numerical setting or other value. For yet other features, a different sort of adjustment or input is required. For example, one menu feature may be a compass calibration mode, in which rangefinder 10 must be placed on a level surface and rotated in the horizontal plane for two full rotations (720 degrees). Many other features, functions, and labels are possible, and the above list should not be construed as limiting the kinds of adjustable features, icons, labels, values, and functions in an optical device according to the present disclosure. In alternative embodiments (not shown), different labels and icons may be used to identify the same or similar functions, and the above labels may be used to identify different functions.

Rangefinder 10 may also include features and capabilities found in other handheld or portable electronic devices. For example, rangefinder 10 may include a GPS sensor (not shown) that determines geographic location of the rangefinder 10 based on GPS satellite signals. GPS location data may be utilized by rangefinder 10 in combination with laser range measurements and compass headings to calculate a geographic position of a distant target, for example.

A method of operation of menu display 54 will now be described with reference to FIGS. 2-4. As shown in FIG. 2, all menu elements 62 of menu display 54 may be briefly displayed simultaneously upon activating a menu mode for adjusting feature settings of rangefinder 10. Simultaneously displaying all menu display elements 62 (the “full menu”) allows the user to preview all of the available feature settings that can be selectively activated, deactivated, or adjusted in the menu mode, described below. This full menu display may also conveniently occur automatically upon powering up rangefinder 10 and before commencing a laser ranging operation. Alternatively, the full menu may be activated upon initially entering the menu mode.

In some embodiments, the benefit of previewing to the user the features available for adjustment in menu mode can be achieved without simultaneously activating all display elements 52 of electronic display 50 or all menu elements 62 of menu display 54. For example, one or more segments 64, 66, 68 of a multi-segment icon 62a, 62b, 62c may be omitted from a full menu display, especially such segments 64, 66, 68 which do not correspond to a current setting. By way of further example, adjustable features that only affect selectable features (such as BOW and A-B-C, which only affect TBR, and DEC, which only affects COMPASS) might not be displayed when the primary feature is not currently active. Moreover, a full menu display may or may not involve display of all elements of targeting display 56 and data display 58. For example, during a full menu display, targeting display 56 and data display 58 may be blanked or left unchanged.

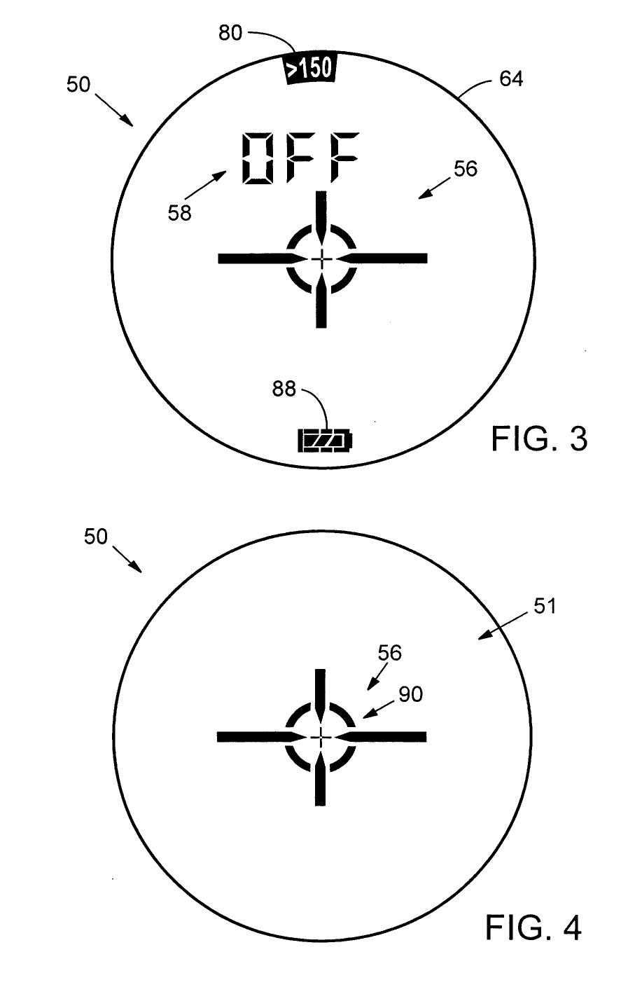

To enter the menu mode, the user may manually depress mode selector button 44 or may otherwise input a menu activation command. After briefly displaying the full menu upon entering the menu mode (e.g., for 0.5 second to several seconds), a first one of the menu icons is then displayed to indicate that a first one of the features of rangefinder 10 is concurrently selected for adjustment. For example, as shown in FIG. 3, a first icon 80 (>150) located at the top center of the field of view (12 o'clock) may be displayed immediately following the full menu display to indicate that the first feature (the long range mode) is selected for adjustment (i.e. for toggling on or off). First icon 80 may be displayed alone, with other menu icons 62 being blanked or otherwise deactivated, as shown in FIG. 3. Alternatively, first icon 80 may be displayed by intermittently flashing or blinking first icon 80, with the remaining menu icons 62 either displayed or blanked. Other modes of displaying or highlighting the first icon 80 may also be employed to signify that the first feature is selected for adjustment. For example, a color, size, or shape of first icon 80 can be changed to emphasize its display. Alternatively, the other (unselected) menu icons can be deemphasized or distinguished from first icon 80 by dimming, coloring, or reducing the size or shape of the unselected menu icons. The setting of the first feature may then be adjusted, or the user may merely leave the first feature setting unchanged and increment through the display menu 54 in a clockwise or counterclockwise manner to select a different feature from the display menu 54 for adjustment.

To adjust the setting of the first feature or any other selected feature, the user may enter a setting adjustment command by depressing setting adjustment button 48, or by some other means, such as an adjustment wheel. In some embodiments, depressing setting adjustment button 48 adjusts the feature setting by toggling it on or off and immediately exiting the menu mode. In other embodiments, depressing setting adjustment button 48 toggles or adjusts the setting of the feature without exiting the menu mode. The original setting or a current setting of the feature, or both, may be displayed in the electronic display 50, for example in data display 58 (as illustrated by the word “Off” in FIG. 3), in menu display 54, or by some other means of user feedback. In some embodiments, a current setting of the selected feature may be displayed dynamically during its adjustment. A dynamic display of a selected feature's current setting may be particularly useful for facilitating user adjustment of functions having a variable set point, such as declination (DEC), for example.

If a selected menu icon includes multiple adjacent segments indicating different possible settings of the selected feature, then the segment corresponding to a current setting of the selected feature may be displayed or flashed. For example, if the menu icon 62a corresponding to the unit of measurement display feature is selected, then one of the segments thereof 64 may be displayed. Alternatively, both the segment corresponding to the original setting and the segment corresponding to the currently adjusted setting may be displayed, with the segment corresponding to the currently adjusted setting preferably being highlighted in some manner, such as by intermittent flashing. The current setting can be adjusted by incrementing through the adjacent segments (e.g. 66), for example by depressing the mode selector button 44 one or more times.

To accept and store an adjusted setting, an accept command may be entered by the user. An accept command may be input by a dedicated acceptance button (not shown) of menu interface 40, or by some other method such as depressing the setting adjustment button 48 then incrementing through the display menu 54 by depressing mode selector button 44, or by some other input or sequence of inputs. Upon acceptance, the adjusted setting is saved, preferably in a computer-readable memory of the electronics of rangefinder 10 or some other associated memory device.

The user may enter mode selection commands to increment through the icons 62 of display menu 54, for example by depressing the mode selector button 44 once for each menu icon 62. Other methods of incrementing or providing a mode selection command may also be employed. The user may increment through the icons 62 of menu display 54 until a selected icon different from the first icon 80 is displayed or highlighted to indicate that a selected feature corresponding to the selected icon is then currently selected for adjustment. Thereafter the selected feature can be adjusted in the same or similar manner as the first feature, as described above.

If a period of inactivity occurs during menu navigation, the menu mode may time-out, which may cause the rangefinder 10 to revert to a ready mode (ready to range a target) or may cause the electronics of rangefinder 10 to be powered down. If the menu mode times out, then any adjustments made to feature settings may be saved. A user may manually exit the menu mode by depressing the power button 30 or depressing and holding one of the menu interface buttons 44, 48.

The arrangement of icons 62 along the periphery or perimeter 64 of the field of view 51 may provide an intuitive user interface that facilitates operation of display menu 54. Conveniently, the menu of rangefinder 10 may be only one level deep, thereby avoiding the complex and confusing menu hierarchies of many prior art aimed optical devices. To further improve the ease and speed of use of display menu 54, first icon 80 preferably corresponds to a feature of rangefinder 10 that is expected to be most often adjusted by users. The second icon in the incremental (clockwise or counterclockwise) rotation of the menu selection is preferably the second most often adjusted feature, the third icon is preferably the third most often adjusted, and so-on. In the embodiment shown, the first icon 80 corresponds to the long range mode feature (>150), the second is for the rain mode (RAIN), etc. Skilled persons will appreciate that the particular ordering of icons 62 around the periphery and sequence of features in the menu is a matter of preference and subject to difference of opinion.

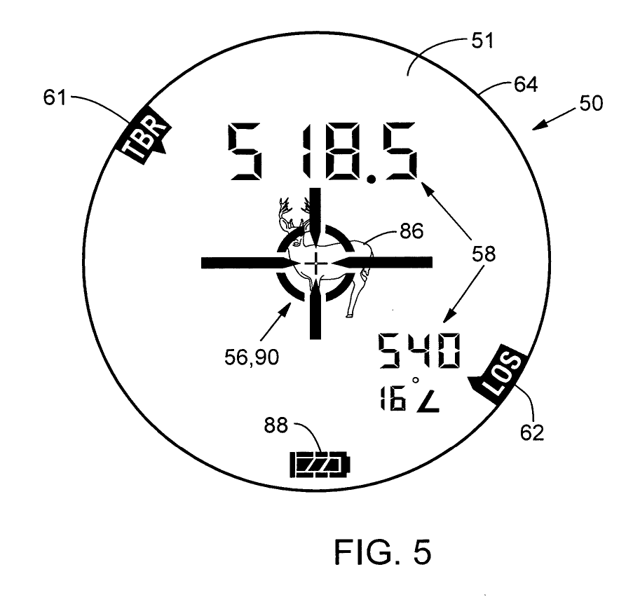

Arrangement of icons 62 along the periphery may also help keep the important central region of the field of view 51 free of confusing and distracting icons or other information that could detract from a user's ability to acquire a target and aim the rangefinder 10. In one embodiment, clutter is reduced in electronic display 50 by displaying only those menu icons 62 critical for proper use of rangefinder 10 or understanding of measurement readouts. At the same time, menu icons for disabled features and any menu icons for active features or settings that are non-critical or for which a user would easily remember their setting, such as the unit of measurement display, can be removed from the display without consequence. One example of selective display of menu icons during ranging is shown in FIG. 5. With reference to FIG. 5, data display 58 reads out a TRUE BALLISTIC RANGE™ of 518.5 yards, a line-of-sight range of 540 yards, and an angle of inclination of 160° to a target 86 viewed through targeting sight 14. The menu icons 62 for TBR and LOS are displayed to distinguish the two different items of range information that are simultaneously displayed in data display 58. Data display 58 may also include a battery charge indicator 88.

### Display Clearing Mode

To further reduce clutter in the field of view 51 and facilitate target acquisition, an optional display clearing mode may be included in rangefinder 10. The clear display mode is illustrated by FIG. 4 in which all menu icons 62 and other elements of electronic display 50 other than a reticle 90 of targeting display 56 are removed without turning off the functions themselves. Although FIG. 4 shows only reticle 90 remaining, in alternative embodiments a limited subset of the elements of menu display 54 or data display 58 may remain displayed in the display clearing mode. In still other embodiments, the display clearing mode may clear all display elements 52, including reticle 90. The display clearing mode may be activated by depressing one or more buttons of rangefinder 10. For instance, in one embodiment, from the ready mode, the setting adjustment button may be depressed and held for more than 1 second to activate the display clearing mode.

### Selectable Reticles

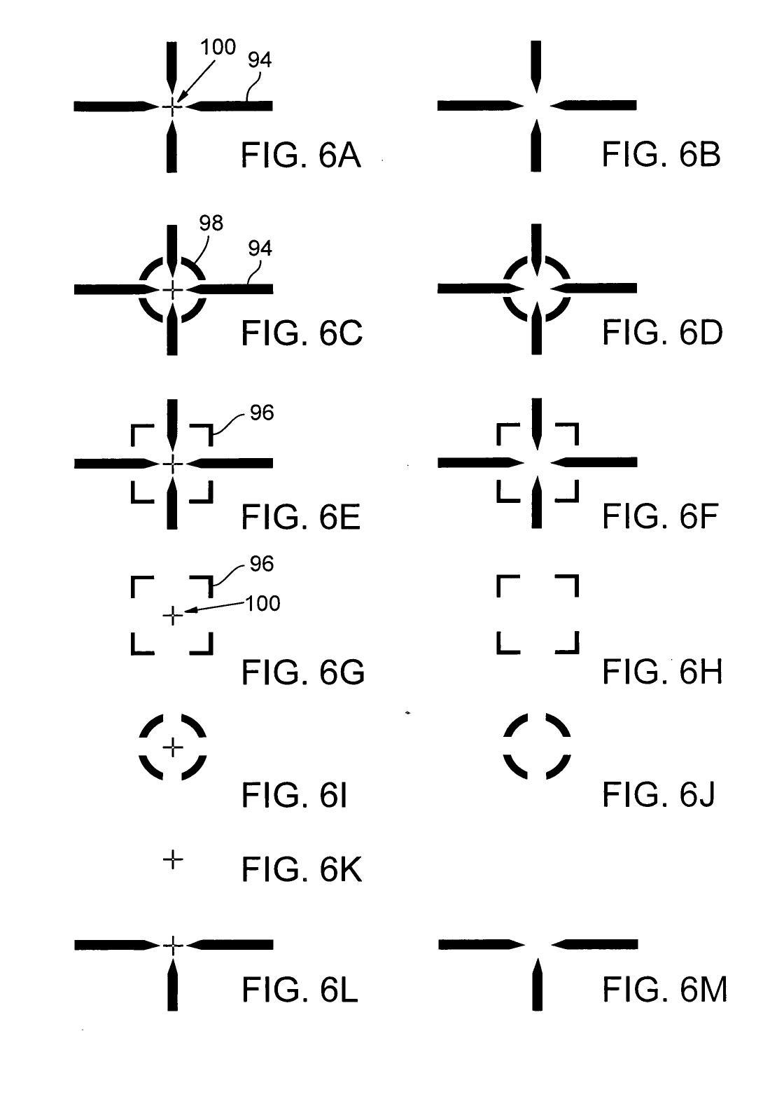

To facilitate aiming at different distances and at different sizes and kinds of targets, reticle 90 may be selected from a variety of different possible reticle configurations shown in FIGS. 6A to 6M. With reference to FIGS. 2 and 6A to 6M, targeting display 56 may include various reticle elements or segments 92, such as radiating posts 94, opposing angle brackets 96, curved brackets 98, and centered crosshairs or PLUS POINT™ 100, for example. Reticles of FIGS. 6A to 6M may be formed by turning on and off various ones or groups of reticle segments 92. For example, a German #4 reticle of FIG. 6M can be formed by turning on the horizontal posts and the lower vertical post, but leaving the upper vertical post turned off.

The PLUS POINT 100, which may be used alone or with other reticle segments 92, provides a very fine reticle that may be useful with or without other heavier reticle segments 92, for aiming at varmints and other small targets. PLUS POINT 100 includes a proprietary open center that is approximately the width and height of the lines thereof, and in the shape of a square. The open center of PLUS POINT 100 avoids obscuring very small or very distant targets, while facilitating aiming of rangefinder 10. Heavier curved brackets 96 and posts 94 may facilitate aiming in low light conditions, with or without PLUS POINT 100.

Thus, the targeting display 56 includes individually controllable reticle segments 92 and groups of reticle segments or elements that can be selectively activated and deactivated by a user to create various reticles (FIGS. 6A-6M and others), which may include symmetrical reticles, asymmetrical reticles, different sizes of reticles, heavy-post reticles, fine-line reticles, and customizable reticles. The number and variety of reticle configurations is limited only by the number of different reticle segments 92 included in targeting display 56. For example, in the embodiment shown, thirteen reticle segments 92 are used to form the thirteen different reticle configurations of FIGS. 6A-6M, although clearly many more variations would be possible using the same elements. Thus, a relatively small number of reticle segments can be employed to form a much larger number of possible reticle configurations.

In some embodiments, a BRACKET CIRCLE™ formed by four curved brackets 98 (as shown in FIGS. 6C, 6D, 61 and 6J) may be sized to bracket a deer at 50 yards. Similarly, all four angle brackets 96 may be displayed to form a BRACKET SQUARE™ (as in FIGS. 6E, 6F, 6G, and 6H), sized to bracket an average elk torso at 40 yards or a deer torso at 30 yards. When combined with posts 94, the BRACKET CIRCLE becomes a BRACKET CIRCLE DUPLEX™ (as shown in FIGS. 6D and 6C), and the BRACKET SQUARE becomes a BRACKET SQUARE DUPLEX™ (as shown in FIGS. 6E and 6F). Targeting sight 14 may include an optical system with 8× magnification and the brackets may therefore be sized for use at the magnification of the optical system. Thus, bracketing capabilities of certain ones of the reticles provide an intuitive mode of rough optical range estimating without laser ranging, in a manner familiar to hunters experienced in using Leupold DUPLEX™ reticles, mil-dot reticles, and other range-estimating riflescope reticles.

The various reticle configurations may be selected or reticles customized as part of the menu mode or in another setup process. In one embodiment, after rotating through all menu icons 62 in menu mode (i.e. after the A-B-C icon 62c), a reticle selection sequence commences in which a user may step through a display of the various reticles (FIGS. 6A-6M) for selection/approval. The user may increment through the various reticle options by continuing to depress the mode selector button 44, as if an extension of the menu mode. When the desired reticle configuration is displayed, it can be selected and set by depressing the setting selector button 48.

After turning on rangefinder 10 and optionally adjusting feature settings, reticle configuration, calibration, and display clearing mode, rangefinder 10 may be utilized to determine the range to a target. After aiming rangefinder 10 at a target using targeting sight 14, the power button 30 is depressed to trigger emission of a laser pulse from laser ranging system 22 and to measure a range to the target 86 (FIG. 5). For purposes of aiming rangefinder 10, reticle 90 is preferably centrally located in the field of view 51 in relatively accurate alignment with the laser beam generated by the laser ranging system 22, so that the laser beam is directed at the central aiming point of reticle 90 (i.e. at the center of the PLUS POINT™ 100 or other reticle elements). The alignment of targeting sight 14 and targeting display 56 relative to laser ranging system 22 may be preset at the factory or may be adjustable by the user, either mechanically or electronically.

### CONCLUSION

Although the selectable reticles and other aspects of electronic display 50, menu display 54, targeting display 56 and data readout 58 are described herein in the context of a rangefinder 10, they may also be readily employed in other kinds of aimed optical devices, such as riflescopes, spotting scopes, telescopes, cameras (digital and film), and video cameras, for example. Moreover, aimed optical devices according to certain embodiments may include monocular optical systems, binocular optical systems, bi-ocular optical systems, telescopes, riflescopes, and others, with or without magnification.

It will be obvious to those having skill in the art that many changes may be made to the details of the above-described embodiments without departing from the underlying principles thereof. The scope of the present invention should, therefore, be determined only by the following claims.

1. A method of operating an interactive menu for adjusting feature settings in an aimed optical device including a digital processor and an optical system for aiming the optical device, the optical system having a field of view bounded by a periphery, the method comprising:
activating a menu display superimposed upon the field of view of the optical device, the menu display including a plurality of menu icons arranged along the periphery of the field of view, each of the menu icons identifying an adjustable feature of the optical device;
displaying a first one of the menu icons to indicate that a first one of the features of the optical device is concurrently selected for adjustment;
in response to receiving a menu selection command from a user, incrementing through the menu icons in a clockwise or counterclockwise manner along the periphery until a selected one of the menu icons different from the first icon is displayed to indicate that a selected one of the features is concurrently selected for adjustment, the selected feature being different from the first feature and having a setting;
selectively adjusting the setting of the selected feature; and
saving the adjusted setting.

2. The method of claim 1, in which the step of displaying the selected menu icon includes intermittently flashing the selected menu icon.

3. The method of claim 1, further comprising, concurrently with displaying the selected menu icon, blanking all other menu icons.

4. The method of claim 1, further comprising, concurrently with displaying the selected menu icon, displaying in the field of view a current setting of the selected feature.

5. The method of claim 4, in which the current setting of the selected feature is displayed dynamically during adjustment thereof.

6. The method of claim 1, in which the selected menu icon includes multiple adjacent segments indicating different possible settings of the selected feature and displaying the selected menu icon includes displaying only the segment corresponding to a current setting of the selected feature.

7. The method of claim 6, in which adjusting the setting of the selected feature includes incrementing through the segments.

8. The method of claim 1, in which:
the selected menu icon includes multiple adjacent segments indicating different possible settings of the selected feature; and
displaying the selected menu icon includes intermittently flashing only the segment corresponding to a current setting of the selected feature.

9. The method of claim 8, in which adjusting the setting of the selected feature includes incrementing through the segments until the desired setting is indicated by intermittent flashing of the corresponding segment.

10. The method of claim 1, in which the optical device includes a mode selector button and the menu selection command is generated by depressing the mode selector button.

11. The method of claim 10, in which the optical device further includes a setting adjustment button and the selective adjustment of the setting includes depressing the setting adjustment button.

12. The method of claim 10, in which the optical device further includes a power button.

13. The method of claim 1, in which saving of the settings includes storing the current setting in a memory readable by the digital processor, in response to receiving an accept command.

14. The method of claim 1, in which the activating of the menu display includes simultaneously displaying all of the menu icons for a brief period.

15. The method of claim 1, further comprising clearing the menu display after saving the adjusted setting, without affecting the setting.

16. The method of claim 15, in which clearing the menu display comprises displaying only a targeting reticle in the field of view during aiming of the optical device.

17. The method of claim 1, in which the aimed optical device is a rangefinder, and further comprising displaying at least two measurement quantities in the field of view.

18. The method of claim 17, in which the two measurement quantities are selected from a group of quantities consisting of:
a) a ballistic range to a target;
b) a line-of-sight range to a target;
c) an angular inclination of the rangefinder;
d) a compass heading of the rangefinder;
d) a GPS position of the rangefinder; and
e) a geographic location of a target.

19. An optical device including an interactive menu operating in accordance with the method of claim 1.

20. An interactive menu system for facilitating the adjustment of feature settings in an aimed optical device including an optical system having a field of view bounded by a periphery, comprising:
an electronic display integrated in the optical system, the electronic display including a plurality of menu icons distributed along the periphery of the field of view, each of the menu icons identifying an adjustable feature of the optical device, at least some of the menu icons being independently controllable for display, and the electronic display being transmissive when not energized; and
a controller including a user interface, the controller operably coupled to the electronic display, the menu display responsive to the controller for displaying a first one of the menu icons to indicate that a first one of the features of the optical device is concurrently selected for adjustment,
the controller adapted to receive a menu selection command via the user interface and, in response, to drive the electronic display to increment through the menu icons in clockwise or counterclockwise fashion along the periphery until a selected one of the menu icons different from the first icon is displayed to indicate that a selected one of the features is concurrently selected for adjustment, and
the controller adapted to receive a setting adjustment command via the user interface and, in response, to adjust the setting of the selected feature.
